(19) United States
(12) Patent Application Publication
(10) Pub. No.: US 2019/0071862 A1
(43) Pub. Date: Mar. 7, 2019

(54) CONNECTION ELEMENT, WIND TURBINE TOWER RING SEGMENT AND METHOD FOR CONNECTING TWO WIND TURBINE TOWER RING SEGMENTS

(71) Applicant: Wobben Properties GmbH, Aurich (DE)

(72) Inventor: Wayne WHITE, Wilhelmshaven (DE)

(21) Appl. No.: 16/091,037

(22) PCT Filed: Apr. 6, 2017
(86) PCT No.: PCT/EP2017/058212

§ 371 Date: Oct. 3, 2018

(30) Foreign Application Priority Data
Apr. 8, 2016 (DE) 10 2016 106 525.0

(51) Int. Cl. E04B 1/41; F03D 13/20; F16B 7/18; E04H 12/12; E04H 5/02

(52) U.S. Cl. CPC E04B 1/41; F03D 13/20; F16B 7/182; E04H 12/342; E04H 5/02; F05B 2230/608; E04H 12/12

(57) ABSTRACT

A connection element, to a wind power installation tower ring segment, to a wind power installation tower portion, to a wind power installation tower, and to a wind power installation, as well as to a method for producing a wind power installation tower ring segment and for connecting two wind power installation tower ring segments. A connection element, specifically a first connection element, for incorporation in a wind power installation tower ring segment, comprising an anchoring bar having a first end and a second end; a connection flange, disposed on the first end of the anchoring bar, for connecting the connection element to a second connection element which is incorporated in a further wind power installation tower ring segment so as to, on account thereof, connect the two wind power installation tower ring segments, at least facilitating the connection of the two latter; and two, three, or a plurality of anchoring elements which are disposed in a portion of the anchoring bar that is contiguous to the second end.

### BACKGROUND

### Technical Field

The invention relates to a connection element, to a wind power installation tower ring segment, to a wind power installation tower portion, to a wind power installation tower, and to a wind power installation, as well as to a method for producing a wind power installation power ring segment and for connecting two wind power installation tower ring segments. The invention furthermore relates to a method for connecting two wind power installation tower portions and to an assembly device for a connection element.

### Description of the Related Art

A wind power installation comprises substantially a rotor comprising at least one rotor blade which is rotationally moved by an airflow and thus by way of an armature drives a generator, wherein the generator is generally disposed within a nacelle. The nacelle is preferably disposed on a tower which is configured either as a steel tower or as a concrete tower, the latter comprising or composed of steel-reinforced concrete and/or pre-stressed concrete. A concrete tower is in particular a tower which is largely fabricated from concrete, wherein however portions can also be produced from another material, preferably steel, or can comprise said material. A tower of this type preferably has a tubular geometry, wherein the diameter of the tower along the longitudinal extent of the latter decreases toward the nacelle. The diameter of a wind power installation tower can at times exceed 8 m.

The tower typically comprises a number of wind power installation tower portions which have an annular geometry having a defined height. The wall configuring the ring furthermore has a thickness. The wind power installation tower portions are preferably disposed alongside one another along the longitudinal extent of the tower in such a manner that the end faces bear substantially completely on one another.

The wind power installation tower portions often comprise a plurality of wind power installation tower ring segments so as to inter-alia simplify the transportation, in particular the delivery of the wind power installation tower portions to the construction site of the wind power installation, by way of components of a comparatively small size. This relates in particular to the wind power installation tower portions which are disposed in the lower region of the tower. A wind power installation tower portion can be assembled, for example, from two tower ring segments which in each case form, for example, a 180-degree segment of the wind power installation tower portion. These tower ring segments are preferably industrially prefabricated as prefabricated concrete parts and are assembled and interconnected in the construction of the tower at the construction site of the wind power installation.

The tower ring segments are assembled in such a manner that said tower ring segments form the annular wind power installation tower portion. In the use of two segments, two joints that run substantially vertically are created on account of the assembly. The joints are created at the location where the tower ring segments abut one another by way of the in each case two abutment locations of said tower ring segments. In the case of known tower ring segments, parts of the reinforcement and/or connection elements typically protrude outward in portions at these abutment locations in order for the tower ring segments to be able to be interconnected here. The connection is preferably performed by a lock bar which connects the reinforcement of one tower ring segment that protrudes outward from a first abutment location to the reinforcement of a further tower ring segment that protrudes outward from a second abutment location. The remaining vertical joint is generally subsequently rendered.

The terms wind power installation tower ring segment and tower ring segment are used synonymously unless this is explicitly explained otherwise. This applies in an analogous manner to wind power installation tower portion and tower portion, and to wind power installation tower and tower.

It is disadvantageous herein that the above is associated with high complexity both in the production of the part-ring segments as well as in the connection of the part-ring segments. Moreover, this type of connection has the risk of corrosion on the reinforcement or connection portions, respectively, in this region, said corrosion potentially arising even in the case of a careful embodiment of the connection. Moreover, the mutual positioning accuracy of the part-ring segments that can be achieved is limited, and is usually in the range of approximately ±10 mm. Moreover, the rendering can be problematic in the case of low temperatures.

Overall, connections, in particular screw connections, for abutments of this type, or the joints created herein, respectively, are typically subject to stringent requirements and by virtue of the latter to in most instances short maintenance intervals which by virtue of the labor-intensive work to be carried out are associated with high costs.

The German patent and trademark office in the context of the priority application pertaining to the present application has researched the following prior art: DE 10 2010 005 991 A1 and DE 20 2006 017 510 U1.

### BRIEF SUMMARY

Provided is a connection element, a wind power installation tower ring segment, a wind power installation tower portion, a wind power installation tower, and a wind power installation, as well as a method for producing a wind power installation tower ring segment and for connecting two tower ring segments, thereby minimizing or eliminating one or a plurality of the disadvantages mentioned. Provided is a connection element, a wind power installation tower ring segment, a wind power installation tower portion, a wind power installation tower, and a wind power installation, as well as a method for producing a wind power installation tower ring segment and for connecting two tower ring segments which reduce the maintenance intensity of the connection of tower ring segments for wind power installation towers. Provided is an improved method for connecting two wind power installation tower portions and an improved assembly device for a connection element.

According to a first aspect of the invention, provided is a connection element, specifically a first connection element, for incorporation in a wind power installation tower ring segment, comprising an anchoring bar having a first end and a second end; a connection flange, disposed on the first end of the anchoring bar, for connecting the connection element to a second connection element which is incorporated in a further wind power installation tower ring segment so as to, on account thereof, connect the two wind power installation tower ring segments, at least facilitating the connection of the two latter; and two, three, or a plurality of anchoring elements which are disposed in a portion of the anchoring bar that is contiguous to the second end.

The connection element is configured for incorporation in a wind power installation tower ring segment. A wind power installation tower typically comprises a plurality of wind power installation tower portions, disposed on top of one another as intended, which are in particular configured as jacket segments and have an annular geometry. By virtue of the at times large diameter of the wind power installation tower portions, the latter often comprise wind power installation tower ring segments which represent a ring portion of a single wind power installation tower portion. Wind power installation tower portions can comprise two or more wind power installation tower ring segments, wherein in particular the use of two tower ring segments for a single tower portion is particularly preferable such that the tower ring segments in each case represent a 180-degree segment of the tower portion, for example. However, a wind power installation tower portion can also comprise three or more tower ring segments. The tower ring segments are preferably composed of or comprise concrete, in particular steel-reinforced concrete and/or pre-stressed concrete. The tower ring segments are preferably interconnected in such a manner that the wind power installation tower meets the requirements set therefor in terms of rigidity.

The invention is based on the concept that the conditions in terms of forces in connections of tower ring segments have a substantial influence on the maintenance intensity required. A low maintenance intensity is distinguished inter alia in that the connection, in particular a screw connection, has to be checked only very rarely, that is to say after very many operating hours. Screw connections in particular in the case of a low maintenance intensity have to be re-tightened only after very many operating hours. In the case of a layout of the connection in such a manner that the forces run substantially or exclusively in the axial direction of a connection element and that the connection element is subjected largely to tensile stress and in particular shearing and/or thrust loads can be reduced, a significantly reduced maintenance intensity is provided. This applies in particular to screw connections, wherein the screw in this instance is subjected largely or exclusively to axial tensile stress.

The incorporation of the connection element in the tower ring segment in particular results in that part of the connection element is disposed substantially within the tower ring segment, in particular within a wall that configures the power ring segment. The tower ring segments accordingly encloses a portion of the connection element such that the connection element is substantially fixedly anchored in the tower ring segment. The connection element is preferably incorporated in the tower ring segment already during the production process of the latter.

The anchoring bar of the connection element has a first end and a second end, the anchoring bar extending longitudinally between said ends. The cross section of the anchoring bar, orthogonal to a substantially longitudinal axis of the anchoring bar, is preferably rectangular having a transverse extent which is aligned so as to be substantially orthogonal to the longitudinal extent, and having a thickness which is aligned so as to be substantially orthogonal to the longitudinal extent and orthogonal to the transverse extent. The thickness can have a significantly smaller dimension than that of the transverse extent, such that the anchoring bar is configured as an elongated plate. The thickness furthermore preferably has a dimension which is smaller than that of the transverse extent. Moreover, the thickness can have the same dimension as that of the transverse extent such that the anchoring bar has a square cross section. The thickness furthermore preferably has a dimension which is larger than that of the transverse extent. The cross section of the anchoring bar can furthermore preferably be configured so as to be polygonal, round, oval, or geometrically non-defined.

The connection flange is disposed on the first end of the anchoring bar. The connection flange is configured so as to connect the connection element to a second connection element which is incorporated in a further wind power installation tower ring segment. The connection flange is preferably configured as a substantially rectangular element which has a flange transverse extent that is parallel with the transverse extent of the anchoring bar, has a height that is parallel with the thickness of the anchoring bar, and has a flange thickness that is parallel with the longitudinal extent of the anchoring bar. The flange transverse extent herein preferably has a larger dimension than the transverse extent of the anchoring bar, and/or the height preferably has a larger dimension than the thickness of the anchoring bar. The flange transverse extent and the height of the connection flange configure a planar extent, the surface normal thereof running substantially parallel with the longitudinal extent of the anchoring bar.

The anchoring bar is furthermore preferably disposed so as to be centric on the planar extent of the connection flange, wherein this can refer to the center of the transverse extent and/or to the center of the height. The extents of the connection flange can also run so as not to be parallel with the aforementioned extents of the anchoring bar such that in each case an angle unequal to zero degrees exists between said extents of the connection flange and of the anchoring bar. The connection flange can moreover also have a square, triangular, polygonal, or oval cross section. Alternatively, the connection flange preferably has a round cross section, in particular a circular cross section.

The external circumferential face of the connection flange is preferably in portions or completely spaced further apart from the central axis of the anchoring bar than the external circumferential face of the anchoring bar. Said external circumferential faces are in particular spaced apart in such a manner that fastening means can be guided through openings that are preferably contained in the connection flange. The thickness of the connection flange is preferably dimensioned in such a manner that said connection flange can absorb forces for connecting two tower ring segments. This applies in particular to the forces during the assembly of the tower and to the forces during the operation of the wind power installation.

The connection flange furthermore preferably has openings which are configured for receiving fastening means. For this purpose, the openings have a preferably circular cross section orthogonally to the penetration direction of said openings. Said cross section is furthermore preferably slot-shaped or polygonal. The openings can furthermore have a penetration direction which is substantially parallel with a surface normal of the planar extent of the connection flange and thus also substantially parallel with the longitudinal extent of the anchoring bar.

The connection flange is preferably non-releasably connected to the first end of the anchoring bar and alternatively preferably releasably connected thereto. The non-releasable connection can be established by means of a welded connection, for example. Furthermore, the connection can have been established already in the production process of the anchoring bar and of the connection flange, for example in that the two components are integrally cast and/or are produced from a single piece of initial material. The releasable connection is preferably performed by means of a screw connection or a bolt connection. The connection can furthermore be performed by way of a tongue-and-groove connection, a feather key, a dovetail connection, and/or a connecting fitting. There is moreover the possibility of a form-fitting connection which can be configured, for example, by way of the detent on the first end of the anchoring bar.

Moreover, a third component which interconnects the anchoring bar and the connection flange by way of a releasable or non-releasable connection can also be used for the connection of the anchoring bar to the connection flange. The connection of the connection flange to the anchoring bar is in particular dimensioned in such a manner that said connection can absorb the forces for connecting two tower ring segments. This applies to the forces during the assembly of the tower and to the forces during the operation of the wind power installation.

The connection element has two, three, or a plurality of anchoring elements which in a portion of the anchoring bar that is contiguous to the second end are disposed such that the anchoring elements are preferably located in a portion of the anchoring bar that is incorporated in the tower ring segment. The anchoring elements serve in particular for anchoring the anchoring bar in the tower ring segment such that the anchoring bar can absorb a high tensile force, engaging on the first end of the anchoring bar, in particular in the longitudinal direction and as a result thereof, despite an impingement by way of a tensile force, does not carry out any substantial movement in the longitudinal direction. The anchoring elements are preferably aligned so as to be substantially parallel with a longitudinal axis of a wind power installation tower and furthermore preferably so as to be orthogonal to a longitudinal axis of the anchoring bar.

In order for a reliable anchoring of the anchoring bar in the tower ring segment to be guaranteed by the anchoring elements, a corresponding fastening of the anchoring elements to the anchoring bar is required. The anchoring elements are preferably fastened to the anchoring bar in such a manner that a tensile force acting on the anchoring bar, in particular a tensile force acting on the first end, is directed into the anchoring elements and by way of the latter into the tower ring segment. The anchoring elements are therefore preferably in each case connected to the anchoring bar in a non-releasable and rigid manner, for example by means of a welded connection.

The material of the connection element is preferably suitable in particular for the absorption of tensile forces and for the incorporation in elements containing concrete. The connection element preferably comprises, or individual component parts of the connection element preferably comprise, a metallic material, preferably steel, in particular stainless steel, and/or a non-ferrous metal, or is/are composed, respectively, of one of said materials or of a combination of said materials. Alternatively, the connection element preferably comprises, or individual component parts of the connection element preferably comprise, one or a plurality of plastic materials, or is/are composed, respectively, of one or a plurality of plastic materials. The anchoring bars and/or connection flanges and/or anchoring elements furthermore preferably comprise dissimilar materials or are composed of the latter.

The field of application of the connection element can go beyond the connection of tower ring segments. It is furthermore possible for the connection elements to be used for interconnecting two wind power installation tower portions which are disposed so as to be vertically mutually neighboring and so as to configure a horizontal abutment. For this purpose, the connection elements in the wind power installation tower portions are disposed so as to be substantially parallel with the longitudinal extent of the tower such that a connection of the connection elements results in a direction of force that runs substantially parallel with the extent of the tower. The other embodiments described herein apply to this application case in an analogous manner, however having the corresponding adaptions in terms of the installation position that is rotated by 90°, in particular in terms of embodiments which refer to horizontal, vertical, lower and/or upper alignments, etc.

In one preferred variant of embodiment of the connection element it is provided that the anchoring elements extend away from a longitudinal axis of the anchoring bar in a substantially orthogonal manner. The anchoring elements accordingly extend away from a longitudinal axis of the anchoring bar at an angle of 90 degrees. Preferably, in each case two anchoring elements extend in the longitudinal direction at the same location of the anchoring bar in two opposite directions that run in parallel away from the anchoring bar. Alternatively, in each case two anchoring elements preferably extend in the longitudinal direction of the anchoring bar so as to be offset in two opposite directions running in parallel away from the anchoring bar. The extents of the anchoring elements can thus at all times be parallel. Alternatively, the extents preferably do not run so as to be parallel, preferably so as to be mutually perpendicular. The arrangement of the anchoring element that is orthogonal to a longitudinal axis of the anchoring bar is advantageous in particular with a view to the connection of the connection element and of the tower ring segment thus being particularly strongly reinforced.

In one further preferred variant of embodiment of the connection element it is provided that the anchoring elements are configured as head bolts. Head bolts, also referred to as head bolts dowels, are typically elements having a pin which in a manner orthogonal to the longitudinal axis thereof has a preferably round cross section which at one end of the longitudinal extent thereof has a thickening of said cross section. The head bolt, by way of the other end of the longitudinal extent thereof, is preferably fastened to the anchoring bar, wherein this fastening is preferably designed so as to be non-releasable, or alternatively so as to be preferably releasable. A connection based on welding technology is particularly preferred, wherein our start welding is in particular used here. The head bolts are preferably produced from a metallic material, in particular from a steel, particularly preferably from a non-corroding material. The head bolts are furthermore preferably produced from a plastic material.

One preferred variant of embodiment provides that an identical number of anchoring elements are disposed, preferably so as to be mutually opposite, in each case on an upper side of the anchoring bar and on a lower side of the anchoring bar. The upper side of the anchoring bar has a surface normal which runs so as to be substantially parallel with a longitudinal axis of the wind power installation tower, said surface in the assembled state of the wind power installation facing the nacelle of the wind power installation. The lower side of the anchoring bar has a surface normal which runs so as to be substantially parallel with a longitudinal axis of the wind power installation tower, said surface in the assembled state of the wind power installation facing the foundation of the wind power installation. It is preferred that in each case two anchoring elements have the same longitudinal axis, one of said anchoring elements being disposed on the upper side and one being disposed on the lower side, such that said anchoring elements are disposed so as to be mutually opposite.

One particularly preferred variant of embodiment provides that the connection flange has two openings which are configured so as to be penetrated in each case by one fastening means. The openings preferably have a penetration direction which runs so as to be substantially parallel with the longitudinal extent of the anchoring bar. The openings furthermore preferably have a cross section, orthogonal to the penetration direction, which is preferably round, in particularly circular. Alternatively, the cross section is preferably configured so as to be slot-shaped or angular. Fastening means provided can penetrate said openings.

The openings are preferably configured as through openings such that the latter have an entry region and an exit region that is different from said entry region. The openings furthermore preferably are configured as blind openings, preferably as blind bores. The arrangement of the two openings such that a fastening means that is guided through said opening in the assembled state and in the operating state can be reached by an operator, for example for maintenance purposes, is particularly preferred. The fastening means is in particular to be reached using a fastening apparatus or the like.

The geometry of the connection element described here in the context of this application also comprises such design embodiments in which the form is adapted to the annular shape of the tower ring segment, or to the tower portion, respectively, and in which the anchoring bar of the connection element is correspondingly aligned in the circumferential direction of the tower ring segment, or of the tower portion, respectively. By virtue of the typically significantly larger radius of a part-ring segment or tower portion, respectively, as compared to the dimensions of the connection element, these embodiments can however also be included in the geometry as described here. Indications such as orthogonal and other geometric indications in the case of a design embodiment that is adapted to the annular shape of the tower ring segment, or of the tower portion, respectively, are to be understood as being adapted in a corresponding manner.

In one further preferred variant of embodiment it is provided that the openings of the connection flange have in each case one internal thread. The internal thread is in particular attached on or in an internal circumferential face of the openings of the connection flange. The internal thread serves in particular for receiving a fastening means, wherein this fastening means preferably has a circular cross section having an external circumferential face. Said external circumferential face in particular has an external thread that corresponds to the internal thread. The internal thread preferably extends completely from an entry region up to an exit region of the opening, such that a fastening means having a corresponding external thread can be partially or completely screwed through the opening and/or into the latter.

In one further particularly preferred variant of embodiment it is provided that the anchoring bar in a manner orthogonal to the longitudinal axis thereof has a circular or rectangular cross section. A circular cross section can preferably have a consistent radius about a central axis, preferably the longitudinal axis of the anchoring bar. The radius about said central axis can furthermore also vary such that an oval cross section is created, for example. A rectangular cross section preferably has four identical angles which are in each case formed by two edges of the anchoring bar cross section. Of the four edges of the anchoring bar cross section, in each case the mutually opposite edges preferably have identical dimensions.

One further particularly preferred variant of embodiment provides that the connection flange and/or the anchoring elements are/is connected to the anchoring bar in a materially integral manner, preferably by welding. The materially integral connection connects the mating partners in such a manner that the mating partners are held together by atomic and/or molecular forces. Materially integral connections can be generated, for example, by soldering/brazing, adhesive bonding, vulcanizing, and/or welding. Welding, and the derivatives of welding, in particular fusion welding and pressure welding, are particularly suitable for joining most metallic materials.

In one further preferred variant of embodiment it is provided that the connection flange and/or the anchoring elements and/or the anchoring bar comprise/comprises steel or are/is composed of steel. It is furthermore preferable for the connection flange and/or the anchoring elements and/or the anchoring bar to comprise casting materials or to be composed thereof. Furthermore, the connection flange and/or the anchoring elements and/or the anchoring bar can be composed of non-ferrous metals such as, for example, special alloys, or can comprise the latter. Furthermore preferably, the connection flange and/or the anchoring elements and/or the anchoring bar can be composed of plastic material or comprise the latter, wherein in particular plastic materials having a high tensile strength, for example fiber-reinforced plastic materials, are preferred. The connection flange and/or the anchoring elements and/or the anchoring bar can furthermore be composed of concrete, in particular high-strength concrete, or comprise the latter.

According to a further aspect of the invention, provided is a wind power installation tower ring segment wherein the tower ring segment is configured as a jacket segment, and preferably as a concrete element, having two abutment locations for placing at least one further wind power installation tower ring segment at abutment locations, and having at least one clearance in the region of each abutment location, wherein in the region of each abutment location in each case one connection element, in particular one connection element as in one of the variants of embodiment described above, is incorporated in the tower ring segment in such a manner that a second end of an anchoring bar by way of anchoring elements is hidden in the tower ring segment, and a first end of the anchoring bar by way of a connection flange protrudes outward into the clearance.

The wind power installation tower ring segment that is preferably configured as a concrete element is in particular a reinforced concrete element and in particular a steel-reinforced concrete element and/or a pre-stressed concrete element. The wind power installation tower ring segment furthermore preferably is present as a prefabricated concrete part which in particular is industrially prefabricated.

The tower ring segment abuts a further tower ring segment at at least two substantially vertical abutment locations. The at least two vertical abutments herein preferably and substantially have the identical vertical dimensions as the height of the tower portion. At least one clearance which preferably on one part is disposed in the first tower ring segment and on the other part is disposed in the second tower ring segment is in each case present at the abutment locations. Two first ends of connection elements, which are incorporated in two different, preferably adjacent, tower ring segments protrude into the clearance. The connection flanges that are disposed on the first ends serve for interconnecting the tower ring segments in that the connection flanges are interconnected by way of a fastening means.

According to a further aspect of the invention provided is a wind power installation tower portion comprising at least one first wind power installation tower ring segment and at least one second wind power installation tower ring segment, in particular a first and a second tower ring segment as in the preceding aspect, wherein the two tower ring segments are in each case configured as a jacket segment, and preferably as a concrete element, and by way of the abutment locations thereof abut one another at at least one substantially vertical abutment, wherein in the region of each abutment location in each case one connection element, in particular a connection element as in at least one of the variants of embodiment described above, is incorporated in the first and in the second wind power installation tower ring segment in such a manner that a second end of an anchoring bar by way of anchoring elements is hidden in the tower ring segment, and a first end of the anchoring bar by way of a connection flange protrudes outward into the clearance, and wherein the connection flanges of the connection elements of the first and of the second tower ring segments are interconnected in the region of the abutment.

The tower portion is preferably configured as a tower ring which configures a complete circle and, in a manner orthogonal to a radius of the tower ring, has a height. The tower ring is preferably formed substantially by a wall, wherein an external circumferential face and an internal circumferential face are configured. The tower portion furthermore comprises at least the first and the second tower ring segment which in the case of a total of two tower ring segments have in each case an angular extent of 180 degrees, for example. There is moreover the possibility for the tower portion to also have more than two tower ring segments, wherein the tower ring segments preferably have a sum of an angular extent of 360 degrees. A partition of the tower portion into tower ring segments offers in particular the advantage of simplified transportation since tower portions having specific diameters can no longer be conveyed in a conventional manner on the usual transportation routes.

The tower ring segments are preferably configured in each case as a jacket segment, preferably as a concrete element. The preferred concrete element is furthermore preferably configured as a reinforced concrete element, in particular as a steel-reinforced concrete element and/or a pre-stressed concrete element. Moreover, the preferred concrete element can preferably be provided as a prefabricated concrete part such that the latter can be industrially prefabricated.

The tower ring segments by way of the abutment locations thereof abut one another at at least one substantially vertical abutment. The at least one vertical abutment herein has a vertical dimension that is preferably and substantially identical to that of the height of the tower portion. In the case of two tower ring segments having, for example, an angular extent of in each case 180 degrees, the tower portion comprises in total two substantially vertical abutments. The number of abutments per tower portion increases accordingly as the number of tower ring segments increases per tower portion.

A clearance is disposed in the region of the abutment. The clearance in terms of one half is preferably disposed in the first tower ring segment that is adjacent to the abutment, and in terms of the other half is disposed in the second tower ring segment that is adjacent to the abutment. The clearance preferably has a geometric shape that is adapted to the connection element, preferably a cuboid shape, wherein the dimensions of the clearance are preferably of such a size that the connection flanges in the assembled state do not have any contact with the border of the clearance. This is particularly advantageous with a view to the connection thus being subjected substantially to tensile stress and, taking into consideration the concept described above, thus enabling a low-maintenance connection.

The connection element of the wind power installation tower portion is preferably configured according to one of the aspects of the invention that have been described above. More than one clearance is provided on an abutment in a further variant of embodiment. This is preferable in particular when the tower portion has a height which enables the provision of more than one clearance. The clearances on a single abutment are preferably disposed vertically on top of one another and preferably have in each case a vertical spacing.

The first ends of the connection elements of the first and of the second tower ring segments protrude into the clearance such that the connection flanges that are disposed on the first ends can be interconnected.

One preferred variant of embodiment of the wind power installation tower portion provides that the connection flanges of the connection elements of the first and of the second tower ring segments are, or are to be, respectively, preferably releasably, interconnected by way of fastening means. The connection flanges have in each case openings, in particular in each case two openings, which can be penetrated by a fastening means. In each case one opening of the one connection flange preferably has the same central axis as an opening of the other connection flange such that said two openings are preferably and substantially disposed in a coaxial manner. The fastening means is preferably introduced through the two coaxially disposed openings. A releasable fastening means is particularly preferred, wherein said releasable fastening means is in particular configured as a screw-fittable fastening means.

According to a further aspect of the invention provided is a wind power installation tower comprising a plurality of wind power installation tower portions, disposed on top of one another as intended, as in at least one of the aspects mentioned above, wherein the abutments of adjacent tower portions are preferably attached so as to be mutually offset. Offset means that the joints of the abutments of two tower portions that are disposed on top of one another are not disposed vertically on top of one another. Abutments that are disposed in a mutually offset manner can increase the rigidity of the tower.

According to a further aspect of the invention a wind power installation comprising a wind power installation tower as in the previously described aspect is provided. The wind power installation, apart from the tower, typically comprises a nacelle disposed on the tower, having an aerodynamic rotor having in most instances three rotor blades and preferably one spinner. The aerodynamic rotor in the operation of the wind power installation is typically set in rotation by the wind and thus typically rotates also a rotor or armature of a generator which can typically be coupled directly or indirectly to the aerodynamic rotor. The electric generator is in most instances disposed in the nacelle in order for electric energy to be generated.

According to a further aspect of the invention provided is a method for producing a wind power installation tower ring segment, in particular a wind power installation tower ring segment as in at least one of the aspects described above, comprising the following method steps: preparing a concrete mold or a formwork for fabricating a tower ring segment; positioning a connection element, in particular a connection element according to at least one of the variants of embodiments described above, in the concrete mold or formwork in such a manner that a first end of an anchoring bar of the connection element by way of a connection flange protrudes outward from a clearance that is disposed in the region of an abutment location; filling the concrete mold or formwork with concrete; curing the concrete; and removing the tower ring segment from the concrete mold or formwork.

The use of a reinforced concrete is particularly preferred, wherein the reinforcement is preferably positioned before the concrete mold and/or formwork is filled and/or topped up with concrete. A plurality of tower segments can optionally also be fabricated simultaneously, said tower segments after curing and removal thereof being separated from one another, wherein the tower ring segments in the concrete mold or the formwork are preferably mutually disposed in such a manner as said tower ring segments are disposed as intended in a wind power installation tower portion and/or wind power installation tower.

According to a further aspect of the invention provided is a method for connecting two tower ring segments to one wind power installation tower portion, in particular to one wind power installation tower portion as in at least one of the aspects described above, comprising the following method steps: providing at least one first wind power installation tower ring segment and at least one second wind power installation tower ring segment, in particular one first and one second wind power installation tower ring segment as in at least one of the aspects described above; and interconnecting the two connection flanges of the first and of the second wind power installation tower ring segments. Interconnecting the two connection flanges is preferably performed by way of a fastening means, in particular by means of a screw connection.

According to a further aspect of the invention provided is a method for connecting two wind power installation tower portions which are disposed so as to be vertically mutually neighboring and so as configure a horizontal abutment. For this purpose, the connection elements in the wind power installation tower portions are disposed so as to be substantially parallel with the longitudinal extent of the tower such that a connection of the connection elements results in a direction of force that runs substantially parallel with the extent of the tower. The other embodiments described herein apply to this application case in an analogous manner, however having the corresponding adaptations in terms of the installation position that is rotated by 90°, in particular in terms of embodiments which refer to horizontal, vertical, lower, and/or upper alignments, etc.

According to a further aspect of the invention provided is an assembly device for a connection element described above, having: a first assembly element comprising a first detent on which at least two first rams are disposed so as to be mutually spaced apart on the same side of the first detent; a second assembly element comprising a second detent on which at least two second rams are disposed so as to be mutually spaced apart on the same side of the second detent, wherein the first and the second rams are disposed and configured so as to be mutually opposite in such a manner so as to jam anchoring bars of two connected connection elements in the orthogonal direction between the first and the second detent.

The assembly device in particular serves for absorbing forces, in particular thrust forces, in the assembled state, the connection in the operating state intended to be substantially free of said forces. However, it can be expedient and desirable in the assembled state, for example when connected tower ring segments are to be relocated or moved, for said forces to be transmitted in order for a high stability of the connection to be guaranteed also in this direction. The assembly device is preferably removed again in the completed installed state upon completion of the assembly, so as to reduce or avoid, respectively, the transmission of forces in this direction, and on account thereof to significantly reduce the maintenance intensity of the connection.

To this end, the assembly device has two assembly elements which have detents which can be configured, for example, as plates and are preferably opposite one another. These detents preferably have mutually facing rams that are aligned so as to be orthogonal to the plates and are preferably expandable orthogonal to the detents such that the anchoring bars of two connected connection elements can be fixedly clamped therebetween. The rams can be configured as holding elements that are guided in threaded sleeves, for example, as will be explained hereunder.

According to one preferred refinement it is provided that the assembly device is configured as follows: having a first assembly element comprising a first detent on which at least two first threaded sleeves are disposed, said threaded sleeves being disposed so as to be mutually spaced apart having in each case one thread on the same side of the first detent; a second assembly element comprising a second detent on which at least two lower threaded sleeves are disposed, said threaded sleeves being disposed so as to be mutually spaced apart having in each case one thread on the same side of the second detent, wherein in each case one holding element is disposed on the first and the second threaded sleeves, wherein the holding elements have in each case one thread that corresponds to the thread of the threaded sleeves, the holding elements being disposed and configured for carrying out axial movements in relation to the central axis of the threaded sleeve on which the holding element is disposed.

In terms of further advantages, variants of embodiments, and details of embodiments of these further aspects and the potential refinements thereof, reference is also made to the description above and to the respective features and refinements of the connection element.

### BRIEF DESCRIPTION OF THE SEVERAL VIEWS OF THE DRAWINGS

Preferred variants of embodiment of the invention will be explained in an exemplary manner by means of the appended figures in which:

FIG. 1: shows a schematic illustration of a wind power installation;

FIG. 2: shows a horizontally sectioned partial view of a tower portion;

FIG. 3: shows a longitudinally sectioned view of a connection element;

FIG. 4: shows a vertically sectioned view of two connection flanges;

FIG. 5: shows a horizontally sectioned view of two connection flanges;

FIG. 6: shows a further view of a connection flange;

FIG. 7: shows a vertically sectioned view of two connection flanges according to FIG. 4, having an assembly device; and

FIG. 8: shows a plan view of an assembly element of the assembly device as per FIG. 7.

### DETAILED DESCRIPTION

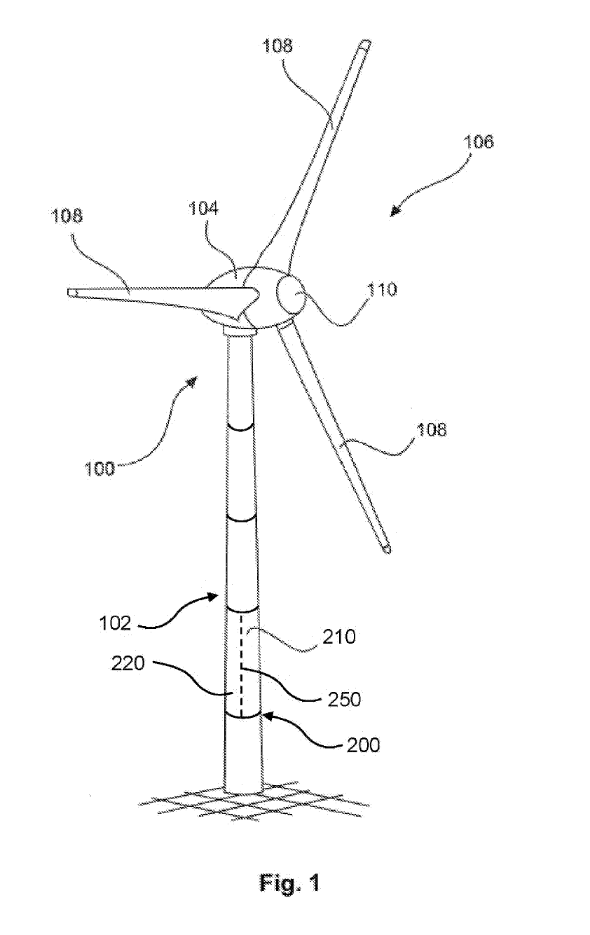

FIG. 1 shows a schematic illustration of a wind power installation according to the invention. The wind power installation 100 has a tower 102 and a nacelle 104 on the tower 102. An aerodynamic rotor 106 having three rotor blades 108 and one spinner 110 is provided on the nacelle 104. The aerodynamic rotor 106 in the operation of the wind power installation is set in a rotational motion by the wind and thus also rotates a rotor or armature of a generator which is coupled directly or indirectly to the aerodynamic rotor 106. The electric generator is disposed in the nacelle 104 and generates electric power. The tower 102 comprises a number of tower portions 200 which are composed substantially of a first tower ring segment 210 and a second tower ring segment 220. The tower ring segments mutually abut at a first abutment 250 and a second abutment (not illustrated).

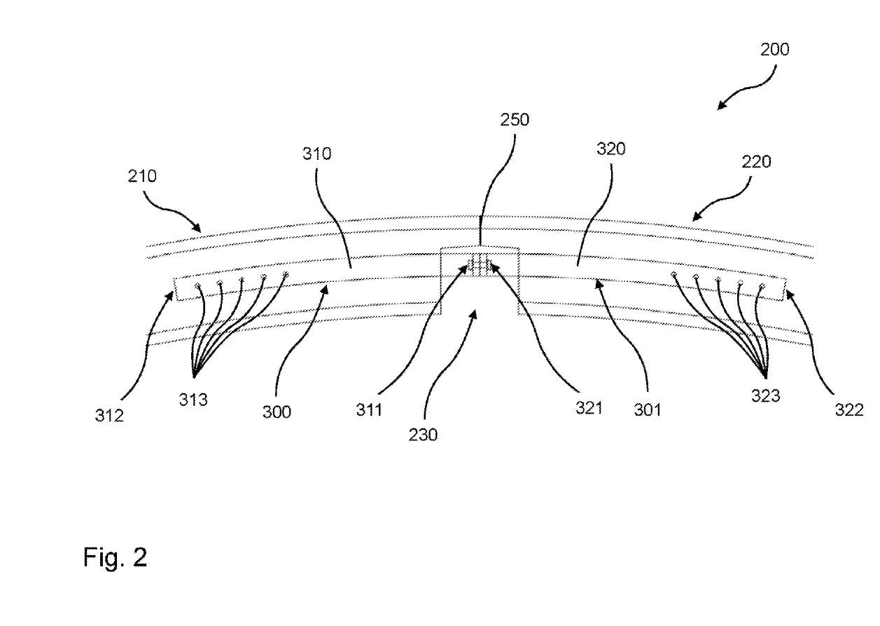

FIG. 2 shows a horizontally sectioned partial view of a tower portion 200. The tower portion 200 comprises a first tower ring segment 210 and a second tower ring segment 220. Said two tower ring segments mutually abut at a vertical abutment 250. The first tower ring segment 210 has a first connection element 300, and the second tower ring segment 220 has a second connection element 301.

The first connection element 300 comprises a first anchoring bar 310 which extends from a first end 311 to a second end 312. The anchoring bar 310 has a substantially rectangular geometry, wherein said anchoring bar 310 has a slight curvature since the anchoring bar runs so as to be substantially parallel with the wall of the tower ring segment 210. The anchoring bar furthermore has anchoring elements 313 which run so as to be orthogonal to the anchoring bar 310 and parallel with a longitudinal axis of the tower portion 200 and are disposed in a region adjacent to the second end 312. A total of ten anchoring elements 313 are disposed on the anchoring bar 310, five of the former being disposed on the upper side and five on the lower side, wherein the lower side having the anchoring elements is not depicted. The first connection element 300 by way of the second end 312 thereof and the region adjacent thereto having the anchoring elements 313 is disposed within the first tower ring segment 210.

The second connection element 301 likewise has an anchoring bar 320 having a first end 321 and a second end 322, wherein anchoring elements 323 are likewise disposed in a region adjacent to the second end 322. The second connection element 301 is likewise disposed so as to be parallel with the wall of the tower ring segment 210, and by way of the second end 322 thereof and the region adjacent thereto having the anchoring elements 323 is disposed within the second tower ring segment 220.

The tower portion 200 furthermore has a clearance 230 on the abutment 250, said clearance 230 in terms of one half being incorporated within the first tower ring segment 210 and in terms of the other half being incorporated within the second tower ring segment. The anchoring bars by way of the first ends 311, 321 thereof protrude into the clearance 230 and are interconnected.

As can be seen in particular in FIG. 2, the shape of the connection elements 300, 301 is adapted to the annular shape of the tower ring segment 200 such that the anchoring bars 311, 312 are accordingly aligned in the circumferential direction of the tower ring segment 200. By virtue of the radius of a part-ring segment or tower portion, respectively, that is typically larger as compared to the dimensions of the connection element, these embodiments can however also be included in the geometry as described here. In particular, indications such as orthogonal and other geometric indications in the case of this design embodiment of the connection elements 300, 301 that is adapted to the annular shape of the tower ring segment 200 are to be understood to be adapted in a corresponding manner.

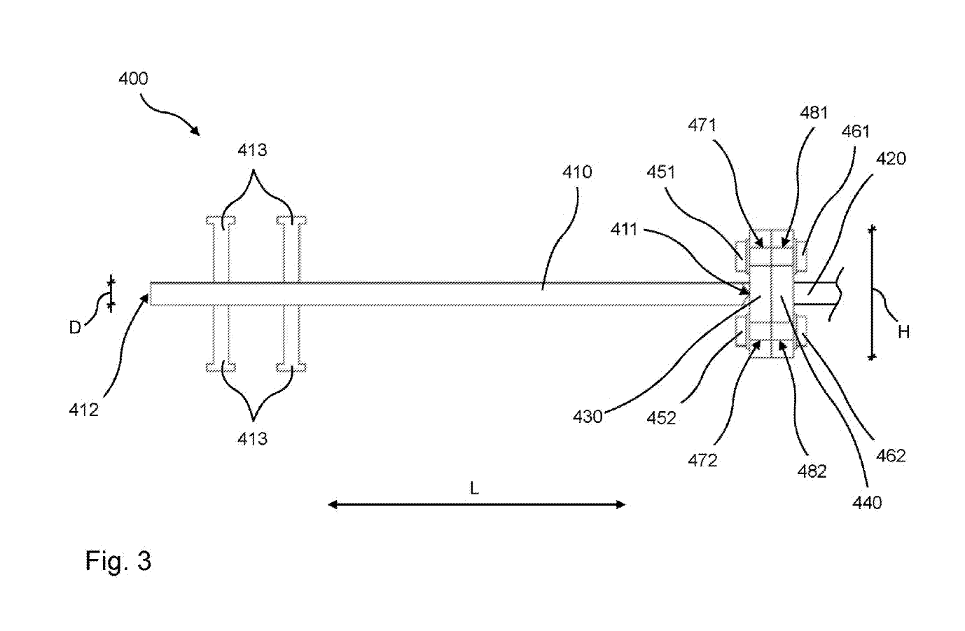

FIG. 3 shows a longitudinally sectioned view of a further variant of embodiment of a connection element 400 having an anchoring bar 410, wherein the anchoring bar 410 extends longitudinally along a longitudinal extent L from a first end 411 to a second end 412, and in a manner orthogonal thereto has a thickness D. A first connection flange 430 which has a height H parallel with the thickness D of the anchoring bar 410 is disposed on the first end 411 of the anchoring bar 410. The dimension of the height H of the first connection flange 430 is larger than the thickness D of the anchoring bar 410. The dimension of the height H of the first connection flange 430 is chosen in such a manner that fastening means 451, 452, here screws, can be introduced into through holes 471, 472 that are incorporated in the connection flange 430. The through holes 471, 472 have a penetration direction which runs so as to be parallel with the longitudinal extent of the anchoring bar 410.

Furthermore, a second connection flange 440 is disposed on the first connection flange 430. The second connection flange 440 is a component part of a second connection element, the second connection flange 440 being disposed on the anchoring bar 420 of said second connection element. The second connection flange 440 is designed in a manner analogous to that of the first connection flange 430. The connection flanges 430, 440 are interconnected in such a manner that the fastening means 451 is introduced or partially guided through, respectively, the upper through hole 471 of the first connection flange 430 and through the upper through hole 481 of the second connection flange 440, and the fastening means 452 is introduced or partially guided through, respectively, the lower through hole 472 of the first connection flange 430 and through the lower through hole 482 of the second connection flange 440. The upper through holes 471, 481 have a common passage. The lower through holes 472, 482 likewise have a common passage. The fastening means 451, 452 on the exit side are secured by corresponding elements 461, 462 such that a connection between the first and the second connection flange 430, 440 is established. Screws are preferably chosen as fastening means, and nuts are preferably chosen as corresponding elements. The connection of the first connection flange 430 to the second connection flange 440 preferably takes place in the clearance of two tower ring segments. Additionally or alternatively, the through holes 471, 472, and/or the through holes 481, 482 have internal threads into which a fastening means 451, 452 can be screwed.

A total of four first anchoring elements 413 which here are embodied as head bolts are disposed in a region adjacent to the second end 412 of the first anchoring bar 410. The first anchoring elements 413 extend orthogonally away from the first anchoring bar 410, in a direction parallel with the thickness D of the first anchoring bar 410. Two first anchoring elements 413 are located on one side of the first anchoring bar 410, and opposite thereto two further first anchoring elements 413 are located on the other side of the first anchoring bar 410.

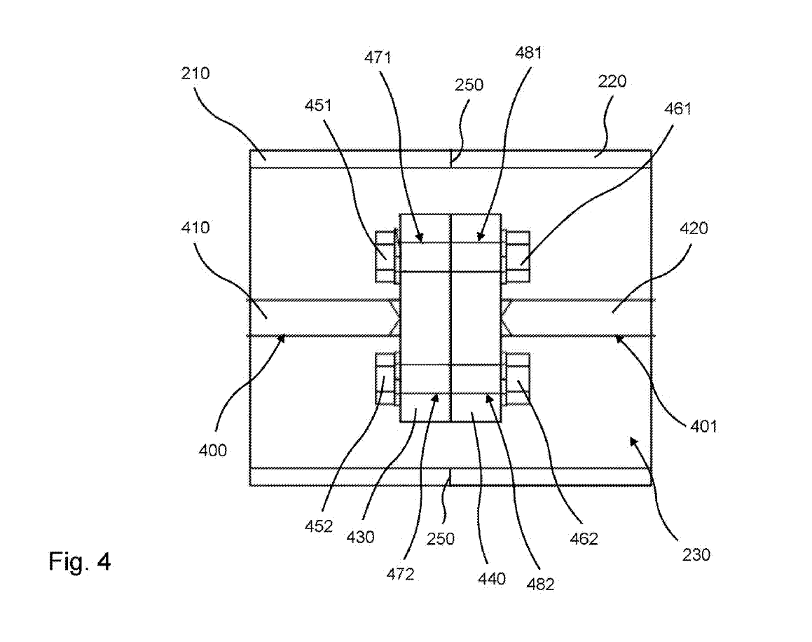

FIG. 4 shows a vertically sectioned view of two connection flanges 430, 440 which are interconnected by means of fastening means 451, 452 and corresponding elements 461, 462, representing a component part of the first connection element 400 or of the second connection element 401, respectively. The first connection flange 430 is connected to the first anchoring bar 410, and the second connection flange 440 is connected to the second anchoring bar 420, wherein the connection is disposed within a clearance 230. Since the anchoring bars 410, 420 are incorporated in the tower ring segments 210, 220 (illustrated only in a fragment in FIG. 4) and are anchored therein, this arrangement serves for interconnecting the tower ring segments 210, 220 at the abutment 250.

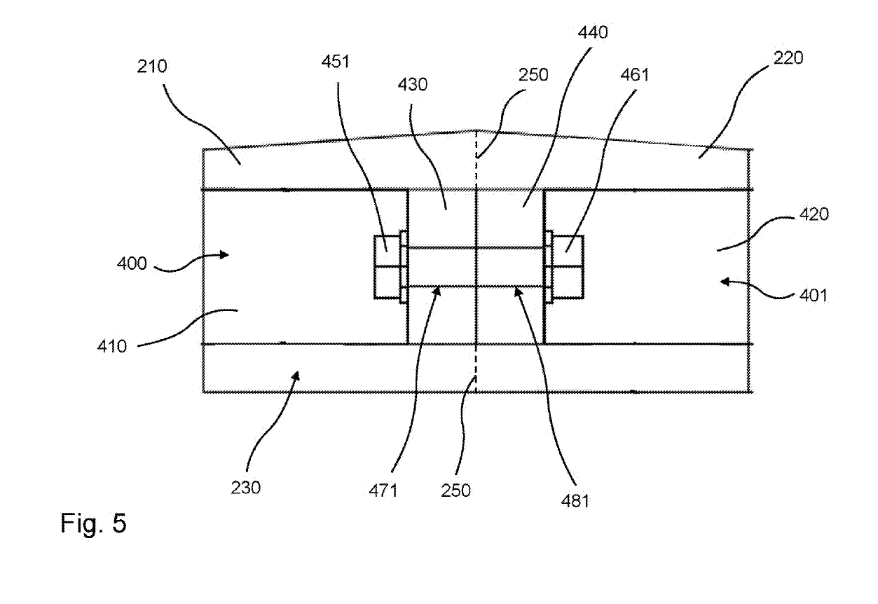

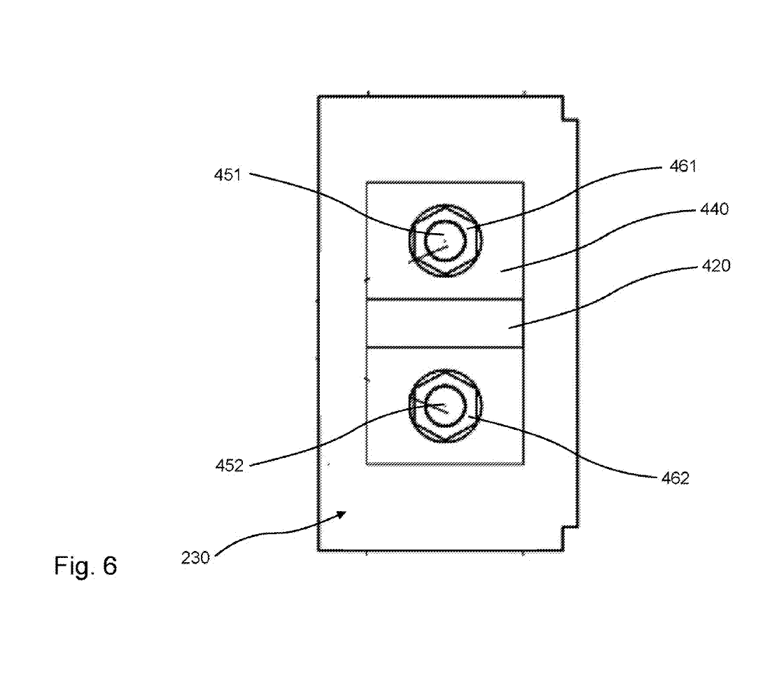

FIG. 5 shows a horizontally sectioned view of the two connection flanges 430, 440 from FIG. 4, having the first and the second anchoring bar 410, 420, which are disposed in the clearance 230. FIG. 6 shows a further view of the connection flange 440 and of the anchoring bar 420 which are disposed in the clearance 230.

On account of the connection of the first connection element 300, 400 to the second connection element 301, 401 a low-maintenance connection of the tower ring segments 210, 220 is enabled. As compared to conventional connections, a low-maintenance connection is distinguished by long maintenance cycles in which the interval between two maintenance operations is comparatively long. This results in the advantage of lower costs by less frequent labor-intensive maintenance activities, on the one hand, and the reliability of the wind power installation being increased, on the other hand.

The maintenance cycles in the use of a connection element according to the disclosure have longer intervals inter alia because forces that run substantially parallel with the longitudinal extent of the anchoring bars 310, 320, 410, 420 act on the connection location where the first anchoring bar 310, 410 is connected to the second anchoring bar 320, 420. The connection location is that location where the first end 311, 411 of the first anchoring bar 310, 410 is connected to the first end 321 of the second anchoring bar 320 by way of a first connection flange 430 and a second connection flange 440, and the fastening means 451, 452 that connect the connection flanges, and by way of elements 461, 462, corresponding to said fastening means 451, 452.

The forces for connecting the two adjacent tower ring segments 210, 220, said forces running substantially parallel with the longitudinal extent of the anchoring bars 310, 320, 410, 420, are furthermore implemented in that the first ends 311, 321, 411 of the anchoring bars 310, 320, 410, 420 and the connection flanges 430, 440 are disposed in a clearance 230 which offers a void around the longitudinal extent of the anchoring bars 310, 320, 410, 420 and thus reduces the transmission of shear forces and/or thrust stresses by way of, or onto, respectively, the connection elements, in particular at the location of the connection flanges 430, 440, the connection, preferably a screw connection, thus not having to absorb any or only very minor shear forces and/or thrust stresses. It has been demonstrated that a connection which has to absorb no or only minor shear forces and/or thrust stresses has a significantly lower maintenance intensity. This advantageous arrangement can be derived in particular from FIGS. 4, 5, and 6. The tower ring segments 210, 220 that meet at the abutment 250 can thus be connected in a reliable manner and so as to have a low maintenance intensity.

Furthermore, the clearance 230 and the connection performed therein, preferably a screw connection, enable simple and reliable checking of the connection since the latter is readily visible to a person carrying out the maintenance. This results in the checking of the connection being associated with a lower effort in terms of time, on the one hand. On the other hand, the checking of the connection by the person testing is associated with an enhanced significance, since the connection can be directly seen and the check therefore has a higher level of validity. The reliability of the wind power installation 100 is thus further enhanced. This is an advantage in particular as compared to connections of tower ring segments to date, which are often rendered and are thus invisible.

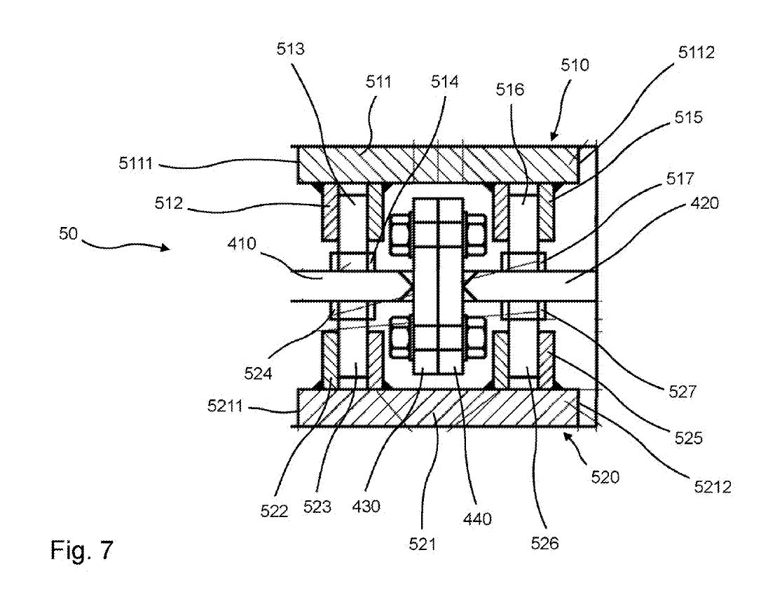

FIG. 7 shows a vertically sectioned view of two connection flanges according to FIG. 4, having an assembly device. The assembly device 50 comprises a first assembly element 510 and a second assembly element 520. The first assembly element 510 comprises a first detent 511 which is configured as a plate. The first detent 511 extends from a first and 5111 up to a second end 5112. A first threaded sleeve 512 (illustrated on the left here) is disposed in a region adjacent to the first end 5111, such that a first threaded sleeve 512 is disposed on the end 5111 of the first detent 511, said first threaded sleeve 512 facing the first anchoring bar 410. The connection of said first threaded sleeve 512 to the first detent 511 here is implemented by way of a weld seam.

A further first threaded sleeve 515 which is disposed on the same side of the detent 511 as the other first threaded sleeve 512 (illustrated on the right here) is disposed in a region adjacent to the second end 5112 of the first detent 511, such that the further first threaded sleeve 515 is disposed on the end 5112 of the first detent 511, said further first threaded sleeve 515 facing the second anchoring bar 420. The further first threaded sleeve 515 likewise has an internal thread. Moreover, a first holding element 513 is disposed on the first threaded sleeve 512, and a further first holding element 516 is disposed on the further first threaded sleeve 515. The holding elements 513, 516 have in each case one external thread that corresponds to the internal thread of the threaded sleeves 512, 515 and are in each case partially screwed into the threaded sleeves.

The second assembly element 520 in principle has the same construction as the first assembly element 510. A second detent 521 extends from a first end 5211 to a second end 5212, wherein second threaded sleeves 522, 525 are disposed in the regions adjacent to the two ends 5211 and 5212. The second threaded sleeves 522, 525 likewise have an internal thread, wherein the second holding elements 523, 526 are screwed into the second threaded sleeves 522. The holding elements 513, 516, 523, 526 in this exemplary embodiment furthermore have in each case first and second hexagons 514, 517, 524, 527, respectively, which are disposed on an end of the holding element which faces away from the associated detent 511, 521, said hexagons 514, 517, 524, 527 thus being able to bear on an anchoring bar 410, 420.

The first and the second assembly element 510, 520 are disposed in a clearance in the region of an abutment of at least two tower ring segments. The arrangement is performed in such a manner that the extent from the first end to the second end runs so as to be substantially parallel with the longitudinal extent of the anchoring bars. Furthermore, the first and the second assembly element 510, 520 are disposed in such a manner that a central axis of the one first threaded sleeve 512 and a central axis of the one second threaded sleeve 522 intersects the first anchoring bar 410. This results in the holding elements 513, 523 in the case of a sufficient protruding length bearing on the anchoring bar 410. A substantially vertical movement of the anchoring bar can be achieved by rotating the holding elements, for example on the hexagons 514, 524.

The same result can be achieved by rotating the further first holding element 516 and the further second holding element 526, in that they are rotated on the hexagons 517, 527, for example. On account of the vertical movement of the anchoring bars, the connection flanges 430, 440 disposed on the anchoring bars 430, 440 can be aligned in such a manner that the upper through holes 471, 481 that are disposed in the flanges have a common through axis, and the lower through holes 472, 482 that are disposed in the flanges likewise have a common through axis. A connection of the flanges by way of fastening means 451, 452 and corresponding elements 461, 462 is thus heavily simplified on account thereof.

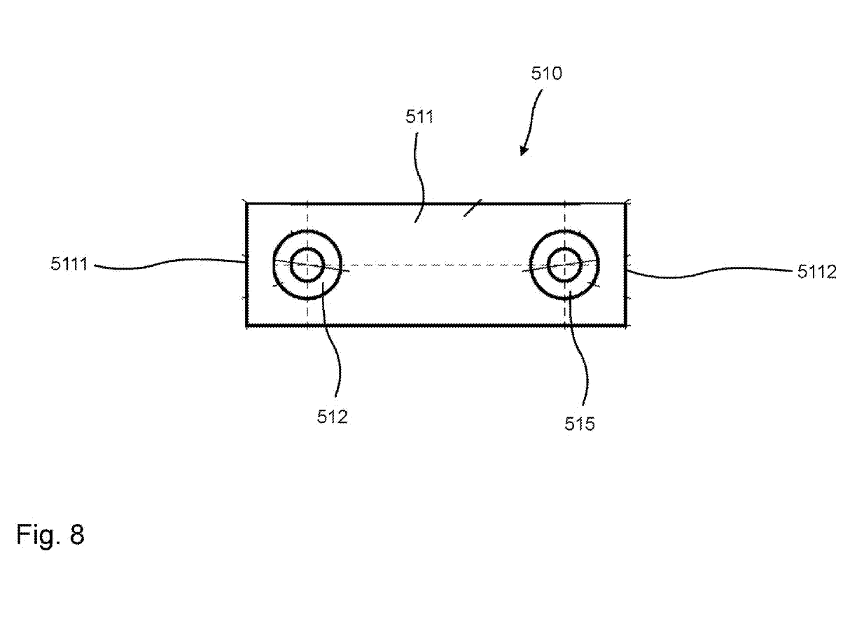

FIG. 8 shows a plan view of an assembly element of the assembly device as per FIG. 7. The assembly element 510 has a longitudinal extent between the first end 5111 and the second end 5112. Furthermore, the assembly element 510, in a manner orthogonal to said longitudinal extent, has a width. The longitudinal extent and the width define a face having a face orthogonal, wherein the two first threaded sleeves 512, 515 are disposed on said face, wherein a central axis of the threaded sleeve 512, 515 runs so as to be substantially parallel with the face orthogonal.

### LIST OF REFERENCE SIGNS

100 Wind power installation

102 Tower

104 Nacelle

106 Rotor

108 Rotor blades

110 Spinner

200 Tower portion

210 First tower ring segment

220 Second tower ring segment

230 Clearance

250 Abutment

300, 400 First connection element

301, 401 Second connection element

310, 410 First anchoring bar

311, 411 First end of the first anchoring bar

312, 412 Second end of the first anchoring bar

313, 413 First anchoring elements

320, 420 Second anchoring bar

321 First end of the second anchoring bar

322 Second end of the second anchoring bar

323 Second anchoring elements

430 First connection flange

440 Second connection flange

451, 452 Fastening means

461, 462 Communicating elements

471, 481 Upper through holes

472, 482 Lower through holes

50 Assembly device

510 First assembly element

511 First detent

512, 515 First threaded sleeves

513, 516 First holding elements

514, 517 First hexagons

520 Second assembly element

521 Second detent

522, 525 Second threaded sleeves

523, 526 Second holding elements

524, 527 Second hexagons

5111 First end of the first detent

5112 Second end of the first detent

5211 First end of the second detent

5212 Second end of the second detent

D Thickness of the anchoring bar

H Height of the connection flanges

L Longitudinal extent

1. A connection element for incorporation in a first wind power installation tower ring segment, the connection element comprising:
an anchoring bar having a first end and a second end,
a connection flange disposed on the first end of the anchoring bar and configured to connect the connection element to a second connection element incorporated in a second wind power installation tower ring segment to thereby connect the first and second wind power installation tower ring segments together, and
a plurality of anchoring elements disposed in a portion of the anchoring bar that is contiguous to the second end.

2. The connection element as claimed in claim 1,
wherein the plurality of anchoring elements extend away from a longitudinal axis of the anchoring bar in a substantially orthogonal manner.

3. The connection element as claimed in claim 1,
wherein an identical number of anchoring elements are disposed so as to be mutually opposite, in each case on an upper side of the anchoring bar and on a lower side of the anchoring bar.

4. The connection element as claimed in claim 1,
wherein the connection flange has two openings configured to receive fastening means, respectively, wherein the two openings of the connection flange have internal threads.

5. The connection element as claimed in claim 1,
wherein the anchoring bar has a circular or rectangular cross section.

6. The connection element as claimed in claim 1,
wherein at least one of the connection flange or the plurality of anchoring elements are fixedly coupled to the anchoring bar.

7. The connection element as claimed in claim 1,
wherein one or more of: the connection flange, the plurality of anchoring elements, and the anchoring bar include steel.

8. A wind power installation tower ring segment comprising:
two abutment locations abutting with other wind power installation tower ring segments at abutment locations, and
at least one clearance in a region of each abutment location, wherein in the region of each abutment location is a connection element as claimed in claim 1, wherein the second end of anchoring bar is anchored in the wind power installation ring segment by way of the plurality of anchoring elements, and wherein the first end of the anchoring bar protrudes from the wind power installation ring segment into the clearance.

9. A wind power installation tower portion comprising:
two wind power installation tower ring segments as claimed in claim 8, wherein the two wind power installation tower ring segments abut each other at an abutment location to form a substantially vertical abutment, wherein the first ends of the anchoring bars of the two wind power installation tower ring segments extend into the clearance, and wherein the connection flanges of the connection elements of the two wind power installation tower ring segments are interconnected in a region of the abutment.

10. The wind power installation tower portion as claimed in claim 9, wherein the connection flanges of the connection elements of the two wind power installation tower ring segments are releasably interconnected by way of fastening means.

11. A wind power installation tower comprising the wind power installation tower portion of claim 9.

12. A wind power installation comprising a wind power installation tower as claimed in claim 10.

13. A method comprising:
producing a wind power installation tower ring segment, wherein producing comprises:
preparing a concrete mold or a formwork for fabricating a wind power installation tower ring segment;
positioning a connection element in the concrete mold or formwork in such a manner that a first end of an anchoring bar of the connection element by way of a connection flange protrudes outward from a clearance that is disposed in the region of an abutment location;
filling the concrete mold or formwork with concrete;
curing the concrete; and
removing the wind power installation tower ring segment from the concrete mold or formwork.

14. The method of claim 13 further comprising:
connecting two wind power installation tower ring segments to one wind power installation tower portion, wherein connecting comprises:
abutting the two wind power installation tower ring segments; and
interconnecting two connection flanges of the two wind power installation tower ring segments.

15. An assembly device for the connection element as claimed in claim 1, the device having:
a first assembly element comprising a first detent, at least two first rams disposed on the first detent so as to be mutually spaced apart on a same side of the first detent;
a second assembly element comprising a second detent, at least two second rams disposed on the second detent so as to be mutually spaced apart on a same side of the second detent;
wherein the at least two first and the at least two second rams are disposed and configured so as to be mutually opposite in such a manner so as to jam anchoring bars of two connected connection elements in an orthogonal direction between the first and the second detents.

16. The connection element as claimed in claim 1, wherein the plurality of anchoring elements are head bolts.

17. The wind power installation tower ring segment as claimed in claim 8, wherein wind power installation tower ring segment is made of concrete

18. The wind power installation tower ring segment as claimed in claim 8, wherein the wind power installation tower ring segment is configured as a jacket segment

19. The wind power installation tower as claimed in claim 11, comprising a plurality of wind power installation power portions disposed on top of one another, wherein the abutments of adjacent wind power installation tower portions are attached so as to be mutually offset.
